(19) United States
(12) Patent Application Publication
(10) Pub. No.: US 2025/0246960 A1
(43) Pub. Date: Jul. 31, 2025

(54) WINDING STRUCTURE FOR ROTATING ELECTRIC MACHINE AND METHOD OF MANUFACTURING THE SAME

(71) Applicant: HONDA MOTOR CO., LTD., Tokyo (JP)

(72) Inventors: Tatsuya Choji, Wako-shi (JP); Shoei Abe, Wako-shi (JP); Manabu Yazaki, Wako-shi (JP); Junji Inoue, Wako-shi (JP); Shogo Shinozaki, Wako-shi (JP); Yuuta Ishii, Wako-shi (JP)

(21) Appl. No.: 19/033,568

(22) Filed: Jan. 22, 2025

(30) Foreign Application Priority Data
Jan. 26, 2024 (JP) 2024-009952
Jan. 26, 2024 (JP) 2024-009953
Jan. 26, 2024 (JP) 2024-009954

(51) Int. Cl. H02K 3/42; H02K 3/18; H02K 15/095

(52) U.S. Cl. CPC H02K 3/42; H02K 3/18; H02K 15/095

(57) ABSTRACT

In a rotating electric machine, a winding is formed by bundling a plurality of unit windings in a radial direction of a stator. A winding structure is formed by the winding being wound around slots. One turn of the winding includes a first axially directed portion, which is one from among a pair of winding regions that extend in an axial direction of the stator, and a second axially directed portion, which is another from among the pair of winding regions. An arrangement order of the plurality of unit windings in the radial direction is mutually reversed in the first axially directed portion and the second axially directed portion.

### CROSS-REFERENCE TO RELATED APPLICATIONS

This application is based upon and claims the benefit of priority from Japanese Patent Applications No. 2024-009952 filed on Jan. 26, 2024, No. 2024-009953 filed on Jan. 26, 2024,and No. 2024-009954 filed on Jan. 26, 2024, the contents of which are incorporated herein by reference.

### BACKGROUND OF THE INVENTION

### Field of the Invention

The present invention relates to a winding structure for a rotating electric machine and a method of manufacturing the same.

### Description of the Related Art

In recent years, in order to ensure that more people will have access to affordable, reliable, sustainable, and modern energy, research and development into energy efficiency has been conducted in various fields, including the field of rotating electric machines. When a circulating current due to a leakage magnetic flux (interlinkage magnetic flux) is generated in a stator of a rotating electric machine, the efficiency of the rotating electric machine decreases. For this reason, for example, in the winding structure disclosed in JP 2008-136300 A, an attempt is made to suppress the generation of such a circulating current by devising a cross-sectional shape of the winding (wire bundle).

### SUMMARY OF THE INVENTION

In the winding structure of JP 2008-136300 A, the circulating current increases depending on how the winding is wound. Therefore, it is desirable to be able to more effectively prevent or suppress the circulating current.

The present invention has the object of solving the aforementioned problem.

A first aspect of the present disclosure is characterized by a winding structure for a rotating electric machine in which a unit winding is formed by bundling a plurality of wires, a winding is formed by bundling a plurality of the unit windings in a radial direction of a stator of the rotating electric machine, and the winding is wound in a slot formed between a plurality of teeth provided in the stator in facing relation to a rotor, wherein a state in which the winding is wound once with respect to the slot is defined as one turn, the one turn includes a first axially directed portion which is one from among a pair of winding regions configured to extend in an axial direction of the stator, and a second axially directed portion which is another from among the pair of winding regions, and an arrangement order of the plurality of unit windings in the radial direction is mutually reversed between the first axially directed portion and the second axially directed portion.

A second aspect of the present disclosure is characterized by a method of manufacturing a winding structure for a rotating electric machine, the winding structure being formed by a wiring that is wound in a slot formed between a plurality of teeth provided in a stator of the rotating electric machine in facing relation to a rotor, the method including providing the winding in which a unit winding is formed by bundling a plurality of wires, and the winding is formed by bundling a plurality of the unit windings, as a first step, and winding the winding around the slot in a manner so that a state in which the winding is wound once with respect to the slot is defined as one turn, the one turn includes a first axially directed portion which is one from among a pair of winding regions configured to extend in an axial direction of the stator, and a second axially directed portion which is another from among the pair of winding regions, and the plurality of unit windings are aligned in a radial direction of the stator, as a second step, wherein, in the second step, by the winding being twisted by 180 degrees between the first axially directed portion and the second axially directed portion, an arrangement order of the plurality of unit windings in the radial direction is mutually reversed between the first axially directed portion and the second axially directed portion.

According to the first aspect and the second aspect of the present disclosure, the arrangement order of the plurality of unit windings is mutually reversed in the first axially directed portion and the second axially directed portion, and therefore, a potential difference within one turn of the winding is canceled out, and the generation of a circulating current can be prevented or suppressed. Hence, it is possible to contribute to energy efficiency.

A third aspect of the present disclosure is characterized by a winding structure for a rotating electric machine in which a unit winding is formed by bundling a plurality of wires, a winding is formed by bundling a plurality of the unit windings in a radial direction of a stator of the rotating electric machine, and the winding is wound in a plurality of slots formed between a plurality of teeth provided in the stator in facing relation to a rotor, wherein a plurality of coil portions constituting a same phase are formed by winding the winding around each of the plurality of slots, and an arrangement order of the plurality of unit windings in the radial direction is reversed between the coil portions that are mutually adjacent to each other in the same phase.

According to the third aspect of the present invention, since the arrangement order of the plurality of unit windings is mutually reversed between the adjacent coil portions, a potential difference between the mutually adjacent coil portions (or between the poles) in the same phase is canceled out, thereby making it possible to prevent or suppress the generation of a circulating current. Hence, it is possible to contribute to energy efficiency.

A fourth aspect of the present disclosure is characterized by a winding structure for a rotating electric machine in which a unit winding is formed by bundling a plurality of wires, a winding is formed by bundling a plurality of the unit windings in a radial direction of a stator of the rotating electric machine, and the winding is wound in a plurality of slots formed between a plurality of teeth provided in the stator in facing relation to a rotor, wherein a plurality of coil portions constituting a same phase are formed by winding the winding around each of the plurality of slots, and a combination concerning relative positions of each of the unit windings from among the plurality of unit windings across the plurality of coil portions in the same phase is same between the plurality of unit windings.

According to the fourth aspect of the present disclosure, at a time when the coil portions in the same phase are viewed as a whole, the positions of the unit windings all become equivalent. Therefore, the potential difference across the plurality of coil portions in the same phase is canceled out, thereby making it possible to prevent or suppress the generation of a circulating current.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a winding structure for a rotating electric machine according to a first embodiment;

FIG. 2 is a cross-sectional view taken along line II-II in FIG. 1;

FIG. 3 is a schematic diagram of the winding structure;

FIG. 4 is a circuit diagram of the winding structure;

FIG. 5 is a flowchart of a method of manufacturing the winding structure;

FIG. 6 is a perspective view of a winding structure for a rotating electric machine according to a second embodiment;

FIG. 7 is a schematic diagram of the winding structure shown in FIG. 6;

FIG. 8 is a circuit diagram of the winding structure shown in FIG. 6;

FIG. 9 is a schematic diagram of a winding structure according to an exemplary modification of the second embodiment;

FIG. 10 is a perspective view of a winding structure for a rotating electric machine according to a third embodiment;

FIG. 11 is a schematic diagram of the winding structure shown in FIG. 10;

FIG. 12 is a circuit diagram of the winding structure shown in FIG. 10; and

FIG. 13 is a schematic diagram of a winding structure according to an exemplary modification of the third embodiment.

### DETAILED DESCRIPTION OF THE INVENTION

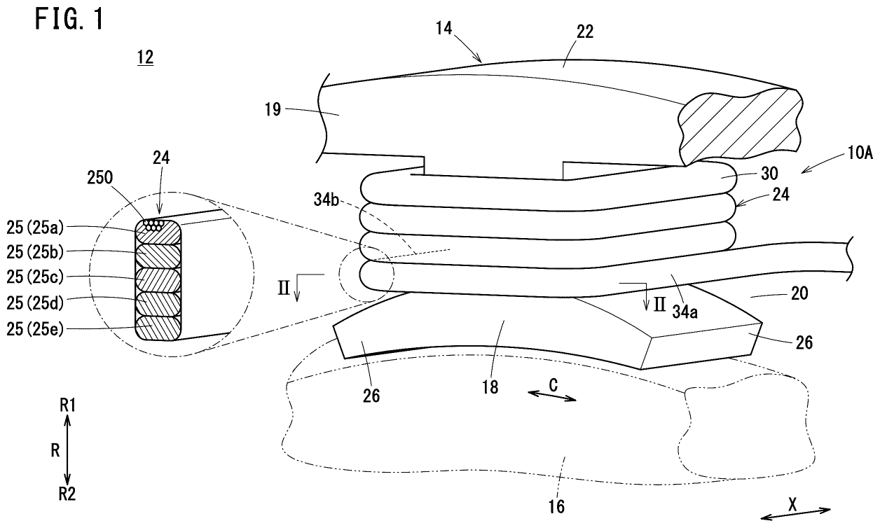

In FIG. 1, a plurality of teeth 18 are provided on a stator 14 of a rotating electric machine 12 in facing relation to a rotor 16. A plurality of slots 20 are formed between the plurality of teeth 18. A winding structure 10A according to the first embodiment of the rotating electric machine 12 is formed by winding a winding 24 around the plurality of slots 20. The rotating electric machine 12 may be an electric motor or an electrical power generating device. The rotating electric machine 12 may be a three-phase AC motor or a three-phase AC electrical power generating device.

The rotating electric machine 12 includes the rotor 16 and the stator 14. A radial direction of the rotor 16 and a radial direction of the stator 14 are the same direction. Therefore, hereinafter, the radial direction of the rotor 16 and the radial direction of the stator 14 may be referred to simply as a “radial direction” without distinguishing therebetween. Moreover, each of the constituent portions of the stator 14 may also be described using the term “radial direction”.

The rotor 16 is supported to be capable of rotating by non-illustrated bearings. In FIG. 1, the rotor 16 is capable of rotating on an inner side of the stator 14. The rotor 16 may be capable of rotating on an outer side of the stator 14. The rotor 16 includes a plurality of permanent magnets. The number of poles of the rotating electric machine 12 corresponds to the number of permanent magnets, and for example, may be 2, 4, 6, 8, or 10 (2 poles, 4 poles, 6 poles, 8 poles, or 10 poles).

The stator 14 is equipped with a stator core 22 and the winding 24. The stator core 22 is made from a magnetic material. The stator core 22 has an annular shaped portion 19 and the plurality of teeth 18. In FIG. 1, an individual one of the teeth 18 is representatively shown. The annular shaped portion 19 constitutes an outer circumferential portion of the stator core 22. The plurality of teeth 18 project out in a radially inward direction (the R2 direction) from the annular shaped portion 19. More specifically, the plurality of teeth 18 project out from the annular shaped portion 19 toward the rotor 16. The plurality of teeth 18 are spaced apart at equal intervals in the circumferential direction of the stator 14. Flange members 26 that project out on both sides in the circumferential direction are provided on radially directed inner ends of the teeth 18.

The winding 24 is an electrical conductor. As the conductor, there is used a wire (a conductive wire) of a material selected from copper, aluminum, or the like. By winding the winding 24 a plurality of times with respect to the slots 20 (the teeth 18), one coil portion 30 is formed. A plurality of the coil portions 30 are arranged at intervals in the circumferential direction of the stator 14. The stator 14 has a plurality of the coil portions 30 for each of a U-phase, a V-phase, and a W-phase. In FIG. 1, one of the coil portions 30 in one of the U-phase, the V-phase, and the W-phase is shown. In FIG. 1, as a method of winding the winding 24, a concentrated winding is illustrated in which one of the coil portions 30 is arranged in each one of the slots 20, however, a distributed winding may also be adopted in which one of the coil portions 30 is arranged across a plurality of the slots 20.

The winding 24 is formed by bundling (overlapping) a plurality of unit windings 25 in the radial direction (the R direction) of the stator 14. More specifically, the plurality of unit windings 25 are arranged in the radial direction of the stator 14. The plurality of unit windings 25 are electrically connected in parallel with each other. In FIG. 1, the winding 24 is divided into five individual unit windings 25.

Each of the unit windings 25 is formed by bundling a plurality of wires 250. In the plurality of unit windings 25, the actual number of the wires 250 that mutually constitutes each of the unit windings 25 is the same. For example, in the case that one winding 24 is made up from 300 strands of the wires 250, the actual number of the strands of the wires 250 constituting each of the unit windings 25 is sixty. Moreover, the number of the unit windings 25 (number of segments) constituting the winding 24 is not limited to being five individual unit windings, but may be two individual unit windings or more.

When the number of the plurality of unit windings 25 is n individual unit windings, in the plurality of unit windings 25, the unit windings 25 are arranged in order in the radial direction from a first unit winding 25a, which is a first one of the unit windings 25, until an nth unit winding 25, which is an nth one of the unit windings 25. According to the present embodiment, since the number of the unit windings 25 is five individual unit windings, a first unit winding 25a, a second unit winding 25b, a third unit winding 25c, a fourth unit winding 25d, and a fifth unit winding 25e are arranged in this order in the radial direction.

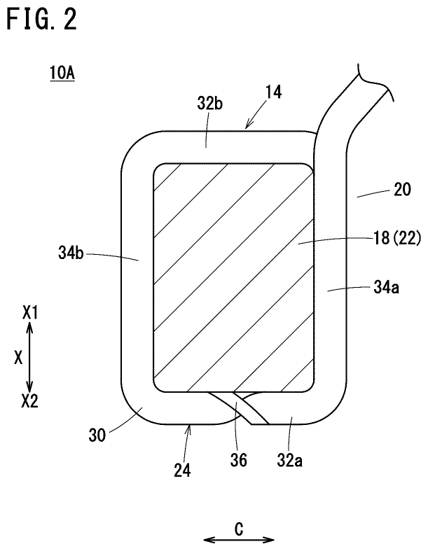

As shown in FIG. 2, a state in which the winding 24 is wound once with respect to the slots 20 is defined as one turn. One of the coil portions 30 is wound a plurality of times, and therefore, includes a plurality of turns. One turn includes a first circumferentially directed portion 32a, a second circumferentially directed portion 32b, a first axially directed portion 34a, and a second axially directed portion 34b. The first circumferentially directed portion 32a and the second circumferentially directed portion 32b extend in the circumferential direction of the stator 14. The first circumferentially directed portion 32a and the second circumferentially directed portion 32b are spaced apart from each other in the axial direction (the X direction) of the stator 14.

The first axially directed portion 34a and the second axially directed portion 34b extend in the axial direction of the stator 14. The first axially directed portion 34a and the second axially directed portion 34b are spaced apart from each other in the circumferential direction (the C direction) of the stator 14. In one turn of the winding 24, the first axially directed portion 34a is one from among a pair of winding regions that extend in the axial direction of the stator 14. In one turn of the winding 24, the second axially directed portion 34b is another from among the pair of winding regions that extend in the axial direction of the stator 14.

One turn is formed by the first circumferentially directed portion 32a, the first axially directed portion 34a, the second circumferentially directed portion 32b, and the second axially directed portion 34b being connected in this order. The first axially directed portion 34a belongs to a front half region of one turn. The second axially directed portion 34b belongs to a rear half region of one turn. The second axially directed portion 34b is continuous with the first circumferentially directed portion 32a of the next turn. Since one of the coil portions 30 is wound a plurality of times, each of the turns is configured as in the above-described manner.

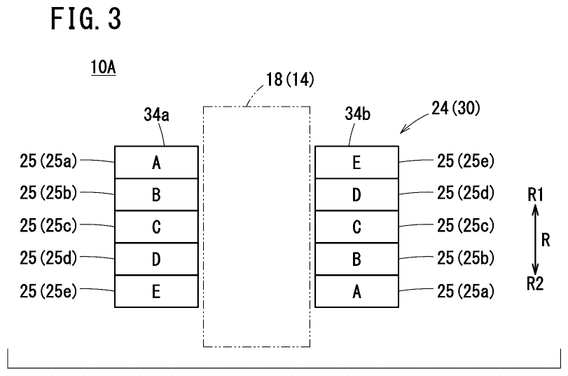

In FIG. 3, the R1 direction is a radially outward direction of the stator 14, and the R2 direction is a radially inward direction of the stator 14. An arrangement order of the plurality of unit windings 25 in the radial direction of the stator 14 is mutually reversed in the first axially directed portion 34a and the second axially directed portion 34b. As noted previously, the stator 14 has the plurality of the coil portions 30 for each of a U-phase, a V-phase, and a W-phase. Therefore, for each of the U-phase, the V-phase, and the W-phase, in each of the plurality of coil portions 30, the arrangement order of the plurality of unit windings 25 in the radial direction is mutually reversed in the first axially directed portion 34a and the second axially directed portion 34b.

Specifically, in one of the first axially directed portion 34a or the second axially directed portion 34b, from within the plurality of unit windings 25, the first unit winding 25a is positioned on an outermost side in the radial direction. In the other of the first axially directed portion 34a or the second axially directed portion 34b, from within the plurality of unit windings 25, the first unit winding 25a is positioned on an innermost side in the radial direction. In the present embodiment, a case is illustrated in which the number of the unit windings 25 is five individual unit windings. Therefore, hereinafter, a description will be given concerning the arrangement order of the first to fifth unit windings 25a to 25e in each turn of the winding 24.

In order to facilitate understanding, in FIG. 3, the first to fifth unit windings 25a to 25e are denoted respectively by the letters A to E. As shown in FIG. 3, in the first axially directed portion 34a, the first to fifth unit windings 25a to 25e are arranged in this order in the radially inward direction (R2). Therefore, in the first axially directed portion 34a, from within the first to fifth unit windings 25a to 25e, the first unit winding 25a is positioned on an outermost side in the radial direction. In the first axially directed portion 34a, from within the first to fifth unit windings 25a to 25e, the fifth unit winding 25e is positioned on an innermost side in the radial direction.

On the other hand, in the second axially directed portion 34b, the first to fifth unit windings 25a to 25e are arranged in this order toward the radially outward direction (R1). Therefore, in the second axially directed portion 34b, from within the first to fifth unit windings 25a to 25e, the first unit winding 25a is positioned on an innermost side in the radial direction. In the second axially directed portion 34b, from within the first to fifth unit windings 25a to 25e, the fifth unit winding 25e is positioned on an outermost side in the radial direction.

As shown in FIG. 2, the winding 24 is twisted 180 degrees between the first axially directed portion 34a and the second axially directed portion 34b. The winding 24 is twisted 180 degrees at approximately a midpoint in one turn (the first circumferentially directed portion 32a). Therefore, the first circumferentially directed portion 32a includes a twisted portion 36. Next, a description will be given concerning a method of manufacturing the winding structure 10A having the twisted portion 36 therein.

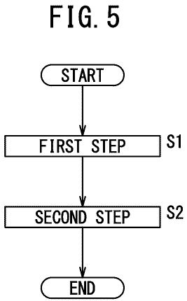

In FIG. 5, the method of manufacturing the winding structure 10A includes a first step S1 and a second step S2. With reference to FIG. 1 or FIG. 2, a description will be given concerning the first step S1 and the second step S2. In the first step S1, a unit winding 25 is formed by bundling the plurality of wires 250, and the winding 24, which is formed by bundling the plurality of unit windings 25, is provided. In the second step S2, one turn of the winding 24 includes the first axially directed portion 34a, which is one from among the pair of winding regions that extend in the axial direction of the stator 14, and the second axially directed portion 34b, which is another from among the pair of winding regions, and further, the winding 24 is wound in the slots 20, in a manner so that the plurality of unit windings 25 are aligned in the radial direction of the stator 14.

Specifically, in the second step S2, the first axially directed portion 34a is wound taking as a starting point one side in the axial direction of the stator 14 (X1 side), and thereafter, the first circumferentially directed portion 32a is wound on another side in the axial direction of the stator 14 (X2 side) that serves as a turn-back position. When winding the first circumferentially directed portion 32a, the winding 24 is twisted by 180 degrees to thereby form the twisted portion 36. In the second step S2, the coil portion 30 having the plurality of turns is formed by winding the winding 24 a plurality of times in a manner so as to form the twisted portion 36 in each of the turns.

As a result, as shown in FIG. 3, in the first axially directed portion 34a belonging to the front half region of one turn, and the second axially directed portion 34b belonging to the rear half region of the one turn, the arrangement order in the radial direction of the first to fifth unit windings 25a to 25e is reversed. In this manner, by the winding 24 being twisted 180 degrees between the first axially directed portion 34a and the second axially directed portion 34b, it is possible to easily realize a structure in which the arrangement order of the unit windings 25 is reversed between the first axially directed portion 34a and the second axially directed portion 34b.

The first embodiment, which is constituted in the manner described above, realizes the following advantageous effects.

During the operation of the rotating electric machine 12 shown in FIG. 1, a leakage magnetic flux is generated in the interior of the rotating electric machine 12. When the leakage magnetic flux acts with respect to the winding 24, an induced electromotive force is caused in each of the unit windings 25. The induced electromotive force becomes greater as the magnetic flux density increases. The magnetic flux density of the leakage magnetic flux in the interior of the rotating electric machine 12 becomes greater in the radially inward direction. Therefore, in the plurality of unit windings 25, in the case that the induced electromotive forces that may be generated due to the leakage magnetic flux mutually differ depending on the relative positions of the respective unit windings 25, a potential difference occurs between the plurality of unit windings 25, and a circulating current is generated.

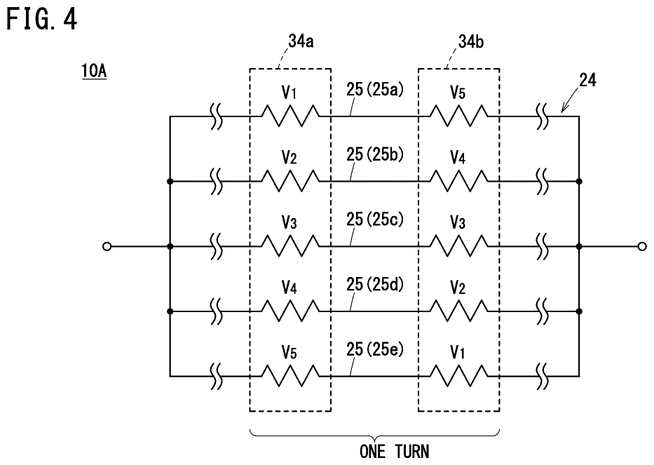

Thus, in accordance with the winding structure 10A of the rotating electric machine 12 according to the present embodiment, the arrangement order of the plurality of unit windings 25 is reversed between the first axially directed portion 34a and the second axially directed portion 34b. In this instance, with reference to FIG. 4, concerning the first to fifth unit windings 25a to 25e, there is shown a magnitude relationship of potential differences generated by the induced electromotive force caused by the leakage magnetic flux in the first axially directed portion 34a and the second axially directed portion 34b. The magnitude relationship of the potential differences that may be generated by the induced electromotive force is V1<V2<V3<V4<V5.

More specifically, in the first axially directed portion 34a, the induced electromotive force (the potential difference that may be generated by the induced electromotive force) in the first unit winding 25a is the smallest, and the induced electromotive force in the fifth unit winding 25e is the largest. In the second axially directed portion 34b, the induced electromotive force in the first unit winding 25a is the largest, and the induced electromotive force in the fifth unit winding 25e is the smallest. As a result, the induced electromotive forces in the first to fifth unit windings 25a to 25e are equalized, and the occurrence of a potential difference among the first to fifth unit windings 25a to 25e is prevented or suppressed. Therefore, it is possible to prevent or suppress the generation of a circulating current within one turn of the winding 24.

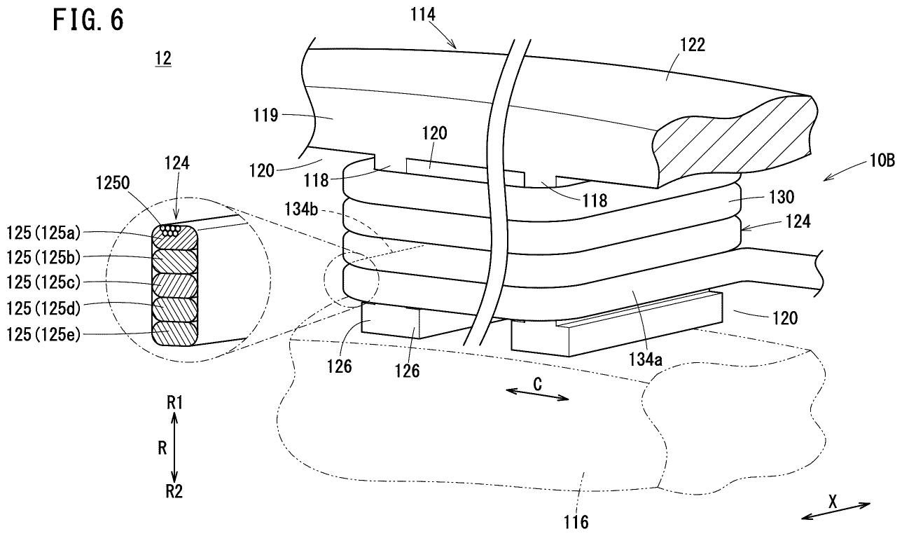

In FIG. 6, a plurality of teeth 118 are provided on a stator 114 of a rotating electric machine 12 in facing relation to a rotor 116. A plurality of slots 120 are formed between the plurality of teeth 118. A winding structure 10B according to a second embodiment of the rotating electric machine 12 is formed by winding a winding 124 around the plurality of slots 120. The rotating electric machine 12 may be an electric motor or an electrical power generating device. The rotating electric machine 12 may be a three-phase AC motor or a three-phase AC electrical power generating device.

The rotating electric machine 12 includes the rotor 116 and the stator 114. A radial direction of the rotor 116 and a radial direction of the stator 114 are the same direction. Therefore, hereinafter, the radial direction of the rotor 116 and the radial direction of the stator 114 may be referred to simply as a “radial direction” without distinguishing therebetween. Moreover, each of the constituent portions of the stator 114 may also be described using the term “radial direction”.

The rotor 116 is supported to be capable of rotating by non-illustrated bearings. In FIG. 6, the rotor 116 is capable of rotating on an inner side of the stator 114. The rotor 116 may also be capable of rotating on an outer side of the stator 114. The rotor 116 includes a plurality of permanent magnets. The number of poles of the rotating electric machine 12 corresponds to the number of permanent magnets, and for example, may be 2, 4, 6, 8, or 10 (2 poles, 4 poles, 6 poles, 8 poles, or 10 poles).

The stator 114 is equipped with a stator core 122 and the winding 124. The stator core 122 is made from a magnetic material. The stator core 122 has an annular shaped portion 119 and the plurality of teeth 118. The annular shaped portion 119 constitutes an outer circumferential portion of the stator core 122. The plurality of teeth 118 project out in a radially inward direction (the R2 direction) from the annular shaped portion 119. More specifically, the plurality of teeth 118 project out from the annular shaped portion 119 toward the rotor 116. The plurality of teeth 118 are spaced apart at equal intervals in the circumferential direction of the stator 114. Flange members 126 that project out on both sides in the circumferential direction are provided on radially directed inner ends of each of the teeth 118.

The winding 124 is an electrical conductor. As the conductor, there is used a wire (a conductive wire) of a material selected from selected from copper, aluminum, or the like. By winding the winding 124 a plurality of times with respect to the slots 120 (the teeth 118), one of coil portions 130 is formed. A plurality of the coil portions 130 are arranged at intervals in the circumferential direction of the stator 114. The stator 114 has a plurality of the coil portions 130 for each of a U-phase, a V-phase, and a W-phase. The coil portions 130 constituting the same phase are electrically connected in series. In FIG. 6, one of the coil portions 130 in one of the U-phase, the V-phase, and the W-phase is representatively shown. In FIG. 6, as a method of winding the winding 124, a distributed winding is illustrated in which one of the coil portions 130 is arranged across a plurality of the slots 120, however, a concentrated winding may also be adopted in which one of the coil portions 130 is arranged in each one of the slots 120.

The winding 124 is formed by bundling (overlapping) a plurality of unit windings 125 in the radial direction (the R direction) of the stator 114. More specifically, the plurality of unit windings 125 are arranged in the radial direction of the stator 114. The plurality of unit windings 125 are electrically connected in parallel with each other. Therefore, in FIG. 6, the winding 124 is divided into five individual unit windings 125.

Each of the unit windings 125 is formed by bundling a plurality of wires 1250. In the plurality of unit windings 125, the actual number of the wires 1250 that mutually constitutes each of the unit windings 125 is the same. For example, in the case that one winding 124 is made up from 300 strands of the wires 1250, the actual number of the strands of the wires 1250 constituting each of the unit windings 125 is sixty. Moreover, the number of the unit windings 125 (number of segments) constituting the winding 124 is not limited to being five individual unit windings, but may be two individual unit windings or more.

When the number of the plurality of unit windings 125 is n individual unit windings, in the plurality of unit windings 125, the unit windings 125 are arranged in order in the radial direction from a first unit winding 125a, which is a first one of the unit windings 125, until an nth unit winding 125, which is an nth one of the unit windings 125. According to the present embodiment, since the number of the unit windings 125 is five individual unit windings, a first unit winding 125a, a second unit winding 125b, a third unit winding 125c, a fourth unit winding 125d, and a fifth unit winding 125e are arranged in this order in the radial direction.

A state in which the winding 124 is wound once with respect to the slots 120 is defined as one turn. One of the coil portions 130 is wound a plurality of times, and therefore, includes a plurality of turns. The one turn includes a first axially directed portion 134a, and a second axially directed portion 134b. The first axially directed portion 134a and the second axially directed portion 134b extend in the axial direction (the X direction) of the stator 114. The first axially directed portion 134a and the second axially directed portion 134b are spaced apart from each other in the circumferential direction (the C direction) of the stator 114. In one turn of the winding 124, the first axially directed portion 134a is one from among a pair of winding regions that extend in the axial direction of the stator 114. The first axially directed portion 134a belongs to a front half region of one turn. In one turn of the winding 124, the second axially directed portion 134b is another from among the pair of winding regions that extend in the axial direction of the stator 114. The second axially directed portion 134b belongs to a rear half region of one turn.

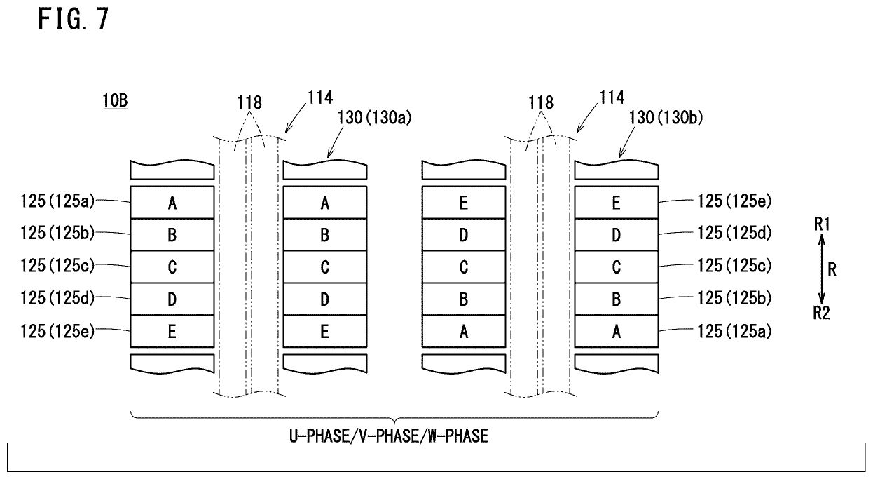

In FIG. 7, the R1 direction is a radially outward direction of the stator 114, and the R2 direction is a radially inward direction of the stator 114. In FIG. 7, mutually adjacent coil portions 130 of the same phase are representatively shown. The arrangement order of the plurality of unit windings 125 in the radial direction of the stator 114 is reversed between the mutually adjacent coil portions 130 in the same phase. As noted previously, the stator 114 has a plurality of the coil portions 130 for each of a U-phase, a V-phase, and a W-phase. Therefore, in each of the U-phase, the V-phase, and the W-phase, the arrangement order of the plurality of unit windings 125 in the radial direction is reversed between the mutually adjacent coil portions 130.

Specifically, in one of the mutually adjacent coil portions 130 (a coil portion 130a), from within the plurality of unit windings 125, the first unit winding 125a is positioned on an outermost side in the radial direction. In the other of the mutually adjacent coil portions 130 (a coil portion 130b), from within the plurality of unit windings 125, the first unit winding 125a is positioned on an innermost side in the radial direction. The plurality of coil portions 130 form a plurality of poles, respectively, in the stator 114. Therefore, the coil portion 130a and the coil portion 130b are mutually adjacent poles in the same phase. In the present embodiment, a case is illustrated in which the number of the unit windings 125 is five individual unit windings. Therefore, hereinafter, a description will be given concerning the arrangement order of the first to fifth unit windings 125a to 125e.

In order to facilitate understanding, in FIG. 7, the first to fifth unit windings 125a to 125e are denoted respectively by the letters A to E. As shown in FIG. 7, in the coil portion 130a, which is one of the mutually adjacent coil portions 130 of the same phase, the first to fifth unit windings 125a to 125e are arranged in this order in the radially inward direction (R2). Therefore, in the coil portion 130a, from within the first to fifth unit windings 125a to 125e, the first unit winding 125a is positioned on an outermost side in the radial direction. In the coil portion 130a, from within the first to fifth unit windings 125a to 125e, the fifth unit winding 125e is positioned on an innermost side in the radial direction.

In the coil portion 130b, which is the other of the mutually adjacent coil portions 130 of the same phase, the first to fifth unit windings 125a to 125e are arranged in this order in the radially outward direction (R1). Therefore, in the coil portion 130b, from within the first to fifth unit windings 125a to 125e, the first unit winding 125a is positioned on an innermost side in the radial direction. In the coil portion 130b, from within the first to fifth unit windings 125a to 125e, the fifth unit winding 125e is positioned on an outermost side in the radial direction.

Moreover, in FIG. 7, concerning each of the coil portions 130, although only one of the turns is designated representatively by the letters A to E, in the one coil portion 130a, the arrangement order of the first to fifth unit windings 125a to 125e is the same for all of the turns. Further, in the other coil portion 130b, the arrangement order of the first to fifth unit windings 125a to 125e is the same for all of the turns.

The second embodiment, which is constituted in the manner described above, realizes the following advantageous effects.

During the operation of the rotating electric machine 12 shown in FIG. 6, a leakage magnetic flux is generated in the interior of the rotating electric machine 12. When the leakage magnetic flux acts with respect to the winding 124, an induced electromotive force is caused in each of the unit windings 125. The induced electromotive force becomes greater as the magnetic flux density increases. The magnetic flux density of the leakage magnetic flux in the interior of the rotating electric machine 12 becomes greater in the radially inward direction. Therefore, in the plurality of unit windings 125, in the case that the induced electromotive forces that may be generated due to the leakage magnetic flux mutually differ depending on the relative positions of each of the unit windings 125, a potential difference occurs between the plurality of unit windings 125, and a circulating current is generated.

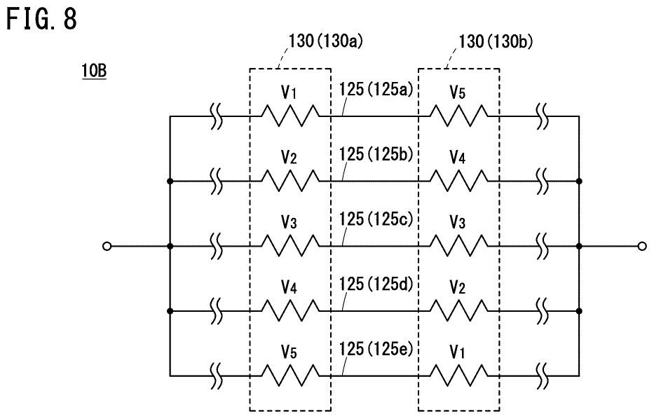

Thus, in accordance with the winding structure 10B of the rotating electric machine 12 according to the second embodiment, the arrangement order of the plurality of unit windings 125 is reversed between the plurality of mutually adjacent coil portions 130 in the same phase. In this instance, with reference to FIG. 8, concerning the first to fifth unit windings 125a to 125e of the mutually adjacent coil portions 130a and 130b in the same phase, there is shown a magnitude relationship of potential differences generated by the induced electromotive force caused by the leakage magnetic flux. The magnitude relationship of the potential differences that may be generated by the induced electromotive force is V1<V2<V3<V4<V5.

More specifically, in the coil portion 130a, the induced electromotive force (the potential difference that may be generated by the induced electromotive force) in the first unit winding 125a is the smallest, and the induced electromotive force in the fifth unit winding 125e is the largest. In the coil portion 130b, the induced electromotive force in the first unit winding 125a is the largest, and the induced electromotive force in the fifth unit winding 125e is the smallest. As a result, the induced electromotive forces in the first to fifth unit windings 125a to 125e are equalized, and the occurrence of a potential difference among the first to fifth unit windings 125a to 125e is prevented or suppressed. Therefore, it is possible to prevent or suppress the generation of a circulating current between the mutually adjacent coil portions 130 (or between the poles) in the same phase.

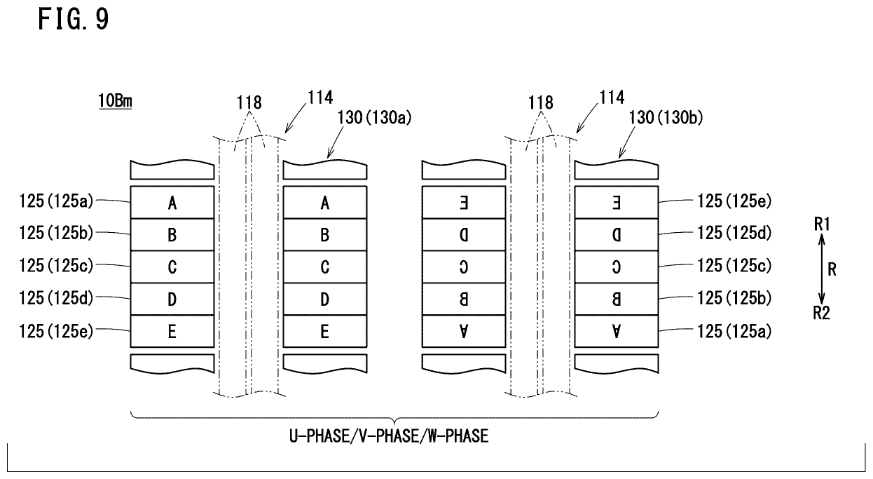

In FIG. 9, there is shown a winding structure 10Bm according to an exemplary modification. In the same manner as in the winding structure 10B (FIG. 7), in the winding structure 10Bm according to the exemplary modification shown in FIG. 9, the arrangement order of the plurality of unit windings 125 in the radial direction is reversed between the plurality of mutually adjacent coil portions 130a and 130b in the same phase. In addition, in the winding structure 10Bm according to the exemplary modification, the orientation with respect to the radial direction of each of the unit windings 125 from the first unit winding 125a until the nth unit winding 125 is inverted by 180 degrees between the mutually adjacent coil portions 130a and 130b in the same phase. In FIG. 9, by the orientation of the symbols A to E in the coil portion 130b becoming upwardly and downwardly reversed with respect to the orientation of the symbols A to E in the coil portion 130a, it is indicated that the orientation of the unit windings 125 between the coil portions 130a and 130b differs by 180 degrees.

In accordance with such a configuration, the potential difference between the wires 1250 (see FIG. 6) in each of the unit windings 125 can also be suppressed. Therefore, the generation of a potential difference can be more effectively prevented or suppressed.

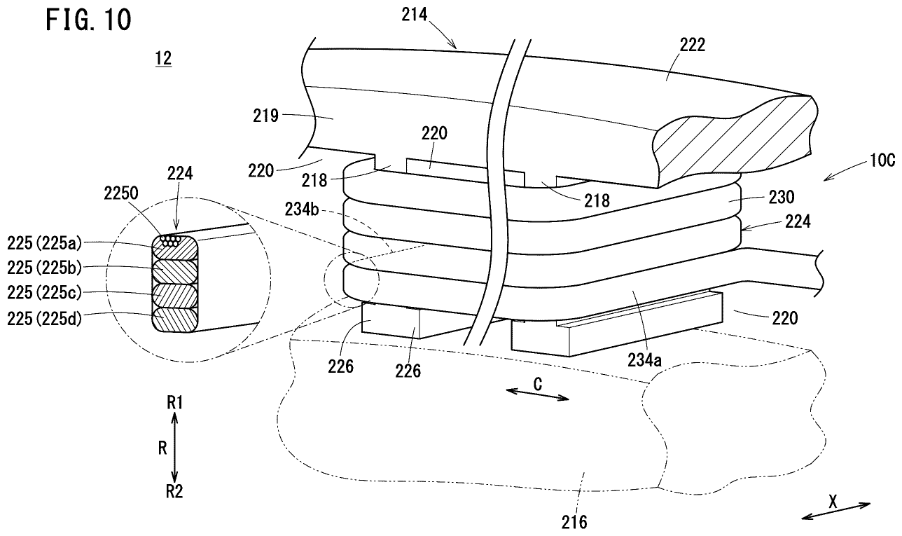

In FIG. 10, a plurality of teeth 218 are provided on a stator 214 of a rotating electric machine 12 in facing relation to a rotor 216. A plurality of slots 220 are formed between the plurality of teeth 218. A winding structure 10C according to a third embodiment of the rotating electric machine 12 is formed by winding a winding 224 around the plurality of slots 220. The rotating electric machine 12 may be an electric motor or an electrical power generating device. The rotating electric machine 12 may be a three-phase AC motor or a three-phase AC electrical power generating device.

The rotating electric machine 12 includes the rotor 216 and the stator 214. A radial direction of the rotor 216 and a radial direction of the stator 214 are the same direction. Therefore, hereinafter, the radial direction of the rotor 216 and the radial direction of the stator 214 may be referred to simply as a “radial direction” without distinguishing therebetween. Moreover, each of the constituent portions of the stator 214 may also be described using the term “radial direction”.

The rotor 216 is supported to be capable of rotating by non-illustrated bearings. In FIG. 10, the rotor 216 is capable of rotating on an inner side of the stator 214. The rotor 216 may also be capable of rotating on an outer side of the stator 214. The rotor 216 includes a plurality of permanent magnets. The number of poles of the rotating electric machine 12 corresponds to the number of permanent magnets, and for example, may be 2, 4, 6, 8, or 10 (2 poles, 4 poles, 6 poles, 8 poles, or 10 poles).

The stator 214 is equipped with a stator core 222 and the winding 224. The stator core 222 is made from a magnetic material. The stator core 222 has an annular shaped portion 219 and the plurality of teeth 218. The annular shaped portion 219 constitutes an outer circumferential portion of the stator core 222. The plurality of teeth 218 project out in a radially inward direction (the R2 direction) from the annular shaped portion 219. More specifically, the plurality of teeth 218 project out from the annular shaped portion 219 toward the rotor 216. The plurality of teeth 218 are spaced apart at equal intervals in the circumferential direction of the stator 214. Flange members 226 that project out on both sides in the circumferential direction are provided on radially directed inner ends of each of the teeth 218.

The winding 224 is an electrical conductor. As the conductor, there is used a wire (a conductive wire) made of a material selected from copper, aluminum, or the like. By winding the winding 224 a plurality of times with respect to the slots 220 (the teeth 218), one coil portion 230 is formed. A plurality of the coil portions 230 are arranged at intervals in the circumferential direction of the stator 214. The stator 214 has a plurality of the coil portions 230 for each of a U-phase, a V-phase, and a W-phase. The coil portions 230 constituting the same phase are electrically connected in series. In FIG. 10, one of the coil portions 230 in one of the U-phase, the V-phase, and the W-phase is representatively shown. In FIG. 10, as a method of winding the winding 224, a distributed winding is illustrated in which one of the coil portions 230 is arranged across a plurality of the slots 220, however, a concentrated winding may also be adopted in which one of the coil portions 230 is arranged in each one of the slots 220.

The winding 224 is formed by bundling (overlapping) a plurality of unit windings 225 in the radial direction (the R direction) of the stator 214. More specifically, the plurality of unit windings 225 are arranged in the radial direction of the stator 214. The plurality of unit windings 225 are electrically connected in parallel with each other. The winding 224 is divided into n individual unit windings 225 corresponding to a number of a plurality of the coil portions 230 in the same phase. In the present embodiment, the number of the coil portions 230 in one phase is four individual coil portions. Therefore, in FIG. 10, the winding 224 is divided into four individual unit windings 225.

Each of the unit windings 225 is formed by bundling a plurality of the wires 2250. In the plurality of unit windings 225, the actual number of the wires 2250 that mutually constitutes each of the unit windings 225 is the same. For example, in the case that one winding 224 is made up of 300 strands of the wires 2250, and further, is divided into four individual unit windings 225, the actual number of the strands of the wires 2250 constituting each of the unit windings 225 is seventy-five.

When the number of the plurality of unit windings 225 is n individual unit windings, in the plurality of unit windings 225, the unit windings 225 include those from a first unit winding 225a, which is a first one of the unit windings 225, until an nth unit winding 225, which is an nth one of the unit windings 225. In the present embodiment, since the number of the unit windings 225 is four individual unit windings, the winding 224 includes a first unit winding 225a, a second unit winding 225b, a third unit winding 225c, and a fourth unit winding 225d. In the first unit winding 225a, the second unit winding 225b, the third unit winding 225c, and the fourth unit winding 225d, the relative positions in the radial direction in the winding 224 differ mutually from each other.

A state in which the winding 224 is wound once with respect to the slots 220 is defined as one turn. One coil portion 230 is wound a plurality of times, and therefore, includes a plurality of turns. The one turn includes a first axially directed portion 234a, and a second axially directed portion 234b. The first axially directed portion 234a and the second axially directed portion 234b extend in the axial direction of the stator 214 (the X direction). The first axially directed portion 234a and the second axially directed portion 234b are spaced apart from each other in the circumferential direction (the C direction) of the stator 214. In one turn of the winding 224, the first axially directed portion 234a is one from among a pair of winding regions that extend in the axial direction of the stator 214. The first axially directed portion 234a belongs to a front half region of one turn. In one turn of the winding 224, the second axially directed portion 234b is another from among the pair of winding regions that extend in the axial direction of the stator 214. The second axially directed portion 234b belongs to a rear half region of one turn.

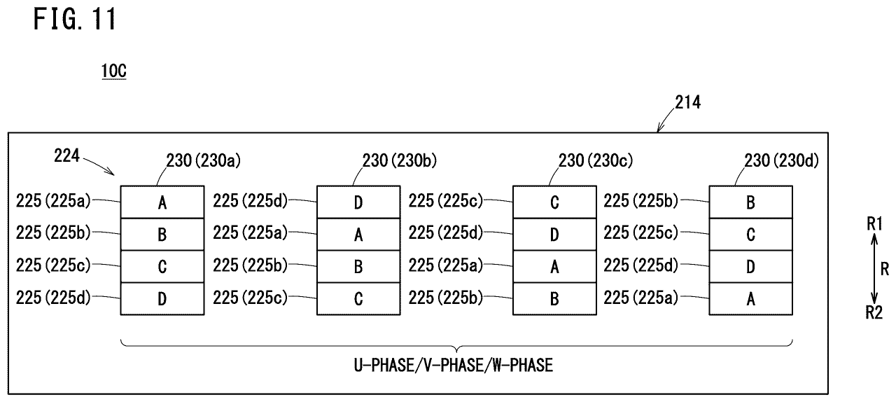

In FIG. 11, the R1 direction is a radially outward direction of the stator 214, and the R2 direction is a radially inward direction of the stator 214. In FIG. 11, a plurality of the coil portions 230 (coil portions 230a to 230d) in the same phase are shown. Concerning the relative positions of each of the unit windings 225 from among the plurality of unit windings 225, the combination across the plurality of coil portions 230 in the same phase is the same among the plurality of unit windings 225. As noted previously, the stator 214 has a plurality of the coil portions 230 for each of a U-phase, a V-phase, and a W-phase. Therefore, in the U-phase, concerning the relative positions of each of the unit windings 225 from among the plurality of unit windings 225, the combination across the plurality of coil portions 230 in the same phase is the same among the plurality of unit windings 225. This same feature applies to the V-phase and the W-phase.

In the plurality of coil portions 230 in the same phase, there are n possible combinations of the arrangement order of the unit windings 225. In the plurality of coil portions 230, when one of the mutually adjacent coil portions 230 is designated as a first coil portion, and another is designated as a second coil portion, in the first coil portion, the first unit winding 225a is positioned at an outermost side in the radial direction, and the nth unit winding 225 is positioned on an innermost side in the radial direction. In the second coil portion, the nth unit winding 225 is positioned on an outermost side in the radial direction, and the others of the unit windings 225 are sequentially shifted by one with respect to the corresponding unit windings 225 in the first coil portion.

The plurality of coil portions 230 form a plurality of poles, respectively, in the stator 214. Therefore, the coil portion 230a and the coil portion 230b are mutually adjacent poles in the same phase. The coil portion 230b and the coil portion 230c are mutually adjacent poles in the same phase. The coil portion 230c and the coil portion 230d are mutually adjacent poles in the same phase. Further, the coil portion 230d and the coil portion 230a are mutually adjacent poles in the same phase. In the present embodiment, a case is illustrated in which, in the winding 224, the number of the unit windings 225 which are divided into a plurality is four individual unit windings. Therefore, hereinafter, a description will be given concerning the arrangement order of the first to fourth unit windings 225a to 225d.

In order to facilitate understanding, in FIG. 11, the first to fourth unit windings 225a to 225d are denoted respectively by the letters A to D. As shown in FIG. 11, in the first coil portion 230a, the first to fourth unit windings 225a to 225d are arranged in this order in the radially inward direction (R2). Therefore, in the coil portion 230a, from within the first to fourth unit windings 225a to 225d, the first unit winding 225a is positioned on an outermost side in the radial direction. In the coil portion 230a, from within the first to fourth unit windings 225a to 225d, the fourth unit winding 225d is positioned on an innermost side in the radial direction.

In the second coil portion 230b, the fourth unit winding 225d is positioned on an outermost side in the radial direction, and the others of the unit windings 225a to 225c are sequentially shifted by one with respect to the corresponding unit windings 225 in the first coil portion 230a. More specifically, in the coil portion 230b, the third unit winding 225c is positioned on an innermost side in the radial direction from among the first to fourth unit windings 225a to 225d, and further, the fourth unit winding 225d, the first unit winding 225a, and the second unit winding 225b are arranged in this order in the radially inward direction.

In the third coil portion 230c, the third unit winding 225c is positioned on an outermost side in the radial direction, and the others of the unit windings 225a, 225b, and 225d are sequentially shifted by one with respect to the corresponding unit windings 225 in the second coil portion 230b. More specifically, in the coil portion 230c, the second unit winding 225b is positioned on an innermost side in the radial direction from among the first to fourth unit windings 225a to 225d, and further, the third unit winding 225c, the fourth unit winding 225d, and the first unit winding 225a are arranged in this order in the radially inward direction.

In the fourth coil portion 230d, the second unit winding 225b is positioned on an outermost side in the radial direction, and the others of the unit windings 225a, 225c, and 225d are sequentially shifted by one with respect to the corresponding unit windings 225 in the third coil portion 230c. More specifically, in the coil portion 230d, the first unit winding 225a is positioned on an innermost side in the radial direction from among the first to fourth unit windings 225a to 225d, and further, the second unit winding 225b, the third unit winding 225c, and the fourth unit winding 225d are arranged in this order in the radially inward direction.

As shown in FIG. 11, concerning the relative positions of each of the unit windings 225 from among the first to fourth unit windings 225a to 225d, the combination across the plurality of coil portions 230a to 230d in the same phase (the U-phase, the V-phase, or the W-phase) all become A+B+C+D, and the same holds true among the first to fourth unit windings 225a to 225d.

Moreover, in FIG. 11, concerning each of the coil portions 230, although only one of the turns is designated representatively by the letters A to D, in the first coil portion 230a, the arrangement order of the first to fourth unit windings 225a to 225d is the same for all of the turns. Further, in the other coil portions 230b to 230d, the arrangement order of the first to fourth unit windings 225a to 225d is the same for all of the turns.

The third embodiment, which is constituted in the manner described above, realizes the following advantageous effects.

During the operation of the rotating electric machine 12 shown in FIG. 10, a leakage magnetic flux is generated in the interior of the rotating electric machine 12. When the leakage magnetic flux acts with respect to the winding 224, an induced electromotive force is caused in each of the unit windings 225. The induced electromotive force becomes greater as the magnetic flux density increases. The magnetic flux density of the leakage magnetic flux in the interior of the rotating electric machine 12 becomes greater in the radially inward direction (the R2 direction). Therefore, in the plurality of unit windings 225, in the case that the induced electromotive forces that may be generated due to the leakage magnetic flux mutually differ depending on the relative positions of each of the unit windings 225, a potential difference occurs between the plurality of unit windings 225, and a circulating current is generated.

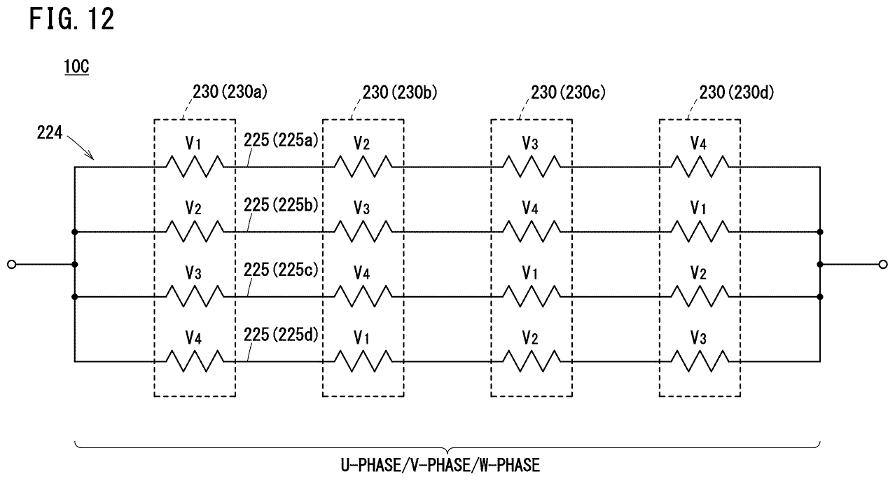

Thus, in accordance with the winding structure 10C of the rotating electric machine 12 according to the third embodiment, in the U-phase, concerning the relative positions of each of the unit windings 225 from among the plurality of unit windings 225, the combination across the plurality of coil portions 230 in the same phase (the U-phase, the V-phase, or the W-phase) is the same among the plurality of unit windings 225. In this instance, with reference to FIG. 12, concerning the first to fourth unit windings 225a to 225d of the plurality of coil portions 230 (the four individual coil portions 230a to 230d) in the same phase, there is shown a magnitude relationship of potential differences generated by the induced electromotive force caused by the leakage magnetic flux. The magnitude relationship of the potential differences that may be generated by the induced electromotive force is V1<V2<V3<V4.

More specifically, in the first coil portion 230a, the induced electromotive force (the potential difference that may be generated by the induced electromotive force) in the first unit winding 225a is the smallest, and the induced electromotive force in the fourth unit winding 225d is the largest. In the second coil portion 230b, the induced electromotive force in the fourth unit winding 225d is the smallest, and the induced electromotive force in the third unit winding 225c is the largest. In the third coil portion 230c, the induced electromotive force in the third unit winding 225c is the smallest, and the induced electromotive force in the second unit winding 225b is the largest. In the fourth coil portion 230d, the induced electromotive force in the second unit winding 225b is the smallest, and the induced electromotive force in the first unit winding 225a is the largest.

Therefore, concerning the potential differences that may be generated caused by the induced electromotive forces in the plurality of unit windings 225a to 225d, the combinations across the plurality of coil portions 230a to 230d in the same phase all become V1+V2+V3+V4, and are the same among the plurality of unit windings 225a to 225d. As a result, at a time when the coil portions 230a to 230d of the same phase are viewed as a whole, the positions of the plurality of unit windings 225a to 225d all become equivalent, and the induced electromotive forces in the plurality of unit windings 225a to 225d are equalized. Therefore, across all of the plurality of coil portions 230 in the same phase, it is possible to prevent or suppress the generation of a circulating current.

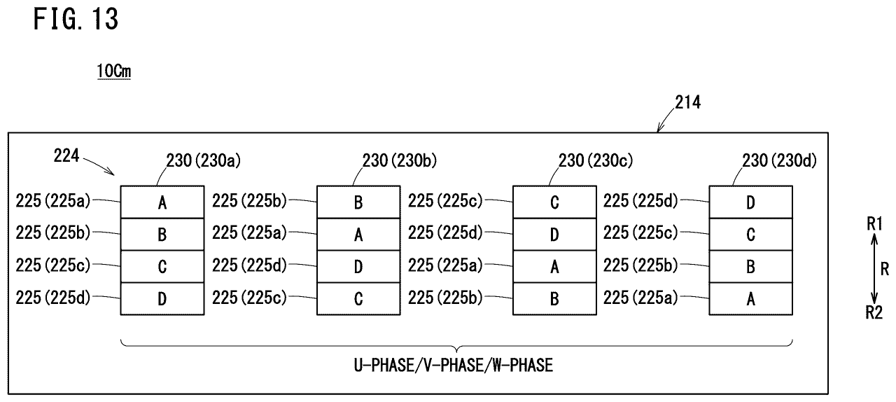

In FIG. 13, there is shown a winding structure 10Cm according to an exemplary modification. In the same manner as in the winding structure 10C (FIG. 11), in the winding structure 10Cm according to the exemplary modification shown in FIG. 13 as well, concerning the relative positions of each of the unit windings 225 from among the plurality of unit windings 225, the combination across the plurality of coil portions 230a to 230d in the same phase all become A+B+C+D, and the same holds true among the plurality of unit windings 225a to 225d. Therefore, in accordance with the winding structure 10Cm according to the exemplary modification as well, it is also possible to prevent or suppress the generation of a circulating current.

In relation to the above-described embodiments, the following supplementary notes are further disclosed.

### Supplementary Note 1

In the winding structure (10A) for the rotating electric machine (12), the unit winding (25) is formed by bundling the plurality of wires (250), the winding (24) is formed by bundling the plurality of unit windings in the radial direction of the stator (14) of the rotating electric machine, and the winding is wound in the slot (20) formed between the plurality of teeth (18) provided in the stator in facing relation to the rotor (16), wherein the state in which the winding is wound once with respect to the slot is defined as one turn, the one turn includes the first axially directed portion (34a), which is one from among the pair of winding regions configured to extend in the axial direction of the stator, and the second axially directed portion (34b), which is another from among the pair of winding regions, and the arrangement order of the plurality of unit windings in the radial direction is mutually reversed between the first axially directed portion and the second axially directed portion.

In accordance with such a configuration, the arrangement order of the plurality of unit windings is mutually reversed in the first axially directed portion and the second axially directed portion, and therefore, a potential difference within one turn of the winding is canceled out, and the generation of a circulating current can be prevented or suppressed. Hence, it is possible to contribute to energy efficiency.

### Supplementary Note 2

In the winding structure for the rotating electric machine according to Supplementary Note 1, the number of the plurality of unit windings may be n, and the plurality of unit windings may be arranged in order from the first unit winding (25a), which is the first one of the unit windings, to the nth unit winding, which is the nth one of the unit windings in the radial direction, in one of the first axially directed portion and the second axially directed portion, the first unit winding from among the plurality of unit windings may be positioned on the outermost side in the radial direction, and in the other of the first axially directed portion and the second axially directed portion, the first unit winding from among the plurality of unit windings may be positioned on the innermost side in the radial direction.

### Supplementary Note 3

In the winding structure for the rotating electric machine according to Supplementary Note 2, the winding may be twisted 180 degrees between the first axially directed portion and the second axially directed portion.

In accordance with such a configuration, it is possible to easily realize a structure in which the arrangement order of the unit windings is reversed between the first axially directed portion and the second axially directed portion.

### Supplementary Note 4

In the winding structure for the rotating electric machine according to any one of Supplementary Notes 1 to 3, the winding may include a plurality of turns due to being wound a plurality of times with respect to the slot.

In accordance with such a configuration, it is possible to prevent or suppress the generation of a circulating current in the coil portion having the plurality of turns.

### Supplementary Note 5

In the winding structure for the rotating electric machine according to any one of Supplementary Notes 1 to 4, the plurality of coil portions (30) may be formed by winding the winding in each of a plurality of the slots, and in each of the plurality of coil portions, the arrangement order of the unit windings in the radial direction may be mutually reversed in the first axially directed portion and the second axially directed portion.

In accordance with such a configuration, the generation of a circulating current in each of the coil portions of the stator can be effectively prevented or suppressed.

### Supplementary Note 6

The method of manufacturing the winding structure (10A) for the rotating electric machine is provided according to the present disclosure. The winding structure is formed by the winding (24) that is wound in the slot (20) formed between the plurality of teeth (18) provided in the stator (14) of the rotating electric machine (12) in facing relation to the rotor (16), and the method of manufacturing the winding structure includes providing the winding in which the unit winding (25) is formed by bundling the plurality of wires (250), and the winding is formed by bundling the plurality of unit windings, as the first step (S1), and winding the winding around the slot in the manner so that the state in which the winding is wound once with respect to the slot is defined as one turn, the one turn includes the first axially directed portion (34a), which is one from among the pair of winding regions configured to extend in the axial direction of the stator, and the second axially directed portion (34b), which is another from among the pair of winding regions, and, the plurality of unit windings are aligned in a radial direction of the stator, as the second step (S2), wherein, in the second step, by the winding being twisted by 180 degrees between the first axially directed portion and the second axially directed portion, the arrangement order of the plurality of unit windings in the radial direction is mutually reversed between the first axially directed portion and the second axially directed portion.

### Supplementary Note 7

In the winding structure (10B) for the rotating electric machine (12), the unit winding (125) is formed by bundling a plurality of wires (1250), the winding (124) is formed by bundling the plurality of unit windings in a radial direction of the stator (114) of the rotating electric machine, and the winding is wound in the plurality of slots (120) formed between the plurality of teeth (118) provided in the stator in facing relation to the rotor (116), wherein the plurality of coil portions (130) constituting the same phase are formed by winding the winding around each of the plurality of slots, and the arrangement order of the plurality of unit windings in the radial direction is reversed between the coil portions that are mutually adjacent to each other in the same phase.

In accordance with such a configuration, since the arrangement order of the plurality of unit windings is mutually reversed between the adjacent coil portions, the potential difference between the mutually adjacent coil portions (or between the poles) in the same phase is canceled out, thereby making it possible to prevent or suppress the generation of a circulating current. Hence, it is possible to contribute to energy efficiency.

### Supplementary Note 8

In the winding structure for the rotating electric machine according to Supplementary Note 7, the number of the plurality of unit windings may be n, the plurality of unit windings may be arranged in order from the first unit winding (125a), which is the first one of the unit windings, to the nth unit winding, which is the nth one of the unit windings in the radial direction, in one of the mutually adjacent coil portions, the first unit winding from among the plurality of unit windings may be positioned on the outermost side in the radial direction, and in the other of the mutually adjacent coil portions, the first unit winding from among the plurality of unit windings may be positioned on the innermost side in the radial direction.

### Supplementary Note 9

In the winding structure for the rotating electric machine according to Supplementary Note 8, the orientation with respect to the radial direction of each of the unit windings from the first unit winding to the nth unit winding may be inverted 180 degrees between the mutually adjacent coil portions in the same phase.

In accordance with such a configuration, the potential difference between the wires in each of the unit windings can also be suppressed. Therefore, the generation of a circulating current can be more effectively prevented or suppressed.

### Supplementary Note 10

In the winding structure for the rotating electric machine according to any one of Supplementary Notes 6 to 9, in each of the plurality of slots, the winding may include a plurality of turns due to being wound a plurality of times.

In accordance with such a configuration, it is possible to prevent or suppress the generation of a circulating current in the coil portion having the plurality of turns.

### Supplementary Note 11

In the winding structure (10C) for the rotating electric machine (12), the unit winding (225) is formed by bundling the plurality of wires (2250), the winding (224) is formed by bundling the plurality of unit windings in the radial direction of the stator (214) of the rotating electric machine, and the winding is wound in the plurality of slots (220) formed between the plurality of teeth (218) provided in the stator in facing relation to the rotor (216), wherein the plurality of coil portions (230) constituting the same phase are formed by winding the winding around each of the plurality of slots, and the combination concerning the relative positions of each of the unit windings from among the plurality of unit windings across the plurality of coil portions in the same phase is the same between the plurality of unit windings.

In accordance with such a configuration, when the coil portions in the same phase are viewed as a whole, the positions of the unit windings all become equivalent. Therefore, the potential difference across the plurality of coil portions in the same phase is canceled out, thereby making it possible to prevent or suppress the generation of a circulating current.

### Supplementary Note 12

In the winding structure for the rotating electric machine according to Supplementary Note 11, the winding may be divided into n individual unit windings corresponding to the number of the plurality of coil portions in the same phase, the plurality of unit windings may include those from the first unit winding (225a), which is the first one of the unit windings, to the nth unit winding, which is the nth one of the unit windings, and there may be n combinations of the arrangement order of the plurality of unit windings.

In accordance with such a configuration, it is possible to easily realize a configuration in which the positions of the plurality of unit windings are all equivalent across the plurality of coil portions as a whole.

### Supplementary Note 13

In the winding structure for the rotating electric machine according to Supplementary Note 12, in the plurality of coil portions, when one of the mutually adjacent coil portions is the first coil portion, and the other of the mutually adjacent coil portions is the second coil portion, in the first coil portion, the first unit winding may be positioned on the outermost side in the radial direction, and the nth unit winding may be positioned on the innermost side in the radial direction, and in the second coil portion, the nth unit winding may be positioned on the outermost side in the radial direction, and the other unit windings may be shifted in sequence by one with respect to the unit windings corresponding to the first coil portion.

In accordance with such a configuration, in the manufacturing process of the stator, when the winding is one from the slot to the next slot, the positions of the unit windings are sequentially shifted by one, thereby making it possible to easily form the winding structure in which the positions of the plurality unit windings are all equivalent throughout the plurality of coil portions.

### Supplementary Note 14

In the winding structure for the rotating electric machine according to any one of Supplementary Notes 11 to 13, in each of the plurality of slots, the winding may include a plurality of turns due to being wound a plurality of times.

In accordance with such a configuration, it is possible to prevent or suppress the generation of a circulating current in the coil portion having the plurality of turns.

Although the present disclosure has been described in detail, the present disclosure is not limited to the individual embodiments described above. These embodiments may be subjected to various additions, substitutions, modifications, partial deletions, and the like, within a range that does not deviate from the essence and gist of the present disclosure, or within a range that does not deviate from the spirit of the present disclosure as derived from the content set forth in the claims and equivalents thereof. These embodiments can also be implemented in combination. For example, in the above-described embodiments, the order of each of the operations and the order of each of the processes are shown as examples, and the present invention is not necessarily limited to these features. The same is also true in the case that numerical values or mathematical formulas are used in the description of the aforementioned embodiments.

1. A winding structure for a rotating electric machine in which a unit winding is formed by bundling a plurality of wires, a winding is formed by bundling a plurality of the unit windings in a radial direction of a stator of the rotating electric machine, and the winding is wound in a slot formed between a plurality of teeth provided in the stator in facing relation to a rotor;
wherein a state in which the winding is wound once with respect to the slot is defined as one turn;
the one turn includes a first axially directed portion which is one from among a pair of winding regions configured to extend in an axial direction of the stator, and a second axially directed portion which is another from among the pair of winding regions; and
an arrangement order of the plurality of unit windings in the radial direction is mutually reversed between the first axially directed portion and the second axially directed portion.

2. The winding structure for the rotating electric machine according to claim 1, wherein:
a number of the plurality of unit windings is n;
the plurality of unit windings are arranged in order from a first unit winding, which is a first one of the unit windings, to an nth unit winding, which is an nth one of the unit windings in the radial direction;
in one of the first axially directed portion and the second axially directed portion, the first unit winding from among the plurality of unit windings is positioned on an outermost side in the radial direction; and
in another of the first axially directed portion and the second axially directed portion, the first unit winding from among the plurality of unit windings is positioned on an innermost side in the radial direction.

3. The winding structure for the rotating electric machine according to claim 2, wherein the winding is twisted 180 degrees between the first axially directed portion and the second axially directed portion.

4. The winding structure for the rotating electric machine according to claim 1, wherein the winding includes a plurality of turns due to being wound a plurality of times with respect to the slot.

5. The winding structure for the rotating electric machine according to claim 1, wherein:
a plurality of coil portions are formed by winding the winding in each of a plurality of the slots; and
in each of the plurality of coil portions, the arrangement order of the unit windings in the radial direction is mutually reversed in the first axially directed portion and the second axially directed portion.

6. A method of manufacturing a winding structure for a rotating electric machine, the winding structure being formed by a wiring that is wound in a slot formed between a plurality of teeth provided in a stator of the rotating electric machine in facing relation to a rotor, the method comprising:
providing the winding in which a unit winding is formed by bundling a plurality of wires, and the winding is formed by bundling a plurality of the unit windings, as a first step; and
winding the winding around the slot in a manner so that a state in which the winding is wound once with respect to the slot is defined as one turn, the one turn includes a first axially directed portion which is one from among a pair of winding regions configured to extend in an axial direction of the stator, and a second axially directed portion which is another from among the pair of winding regions, and the plurality of unit windings are aligned in a radial direction of the stator, as a second step;
wherein, in the second step, by the winding being twisted by 180 degrees between the first axially directed portion and the second axially directed portion, an arrangement order of the plurality of unit windings in the radial direction is mutually reversed between the first axially directed portion and the second axially directed portion.

7. A winding structure for a rotating electric machine in which a unit winding is formed by bundling a plurality of wires, a winding is formed by bundling a plurality of the unit windings in a radial direction of a stator of the rotating electric machine, and the winding is wound in a plurality of slots formed between a plurality of teeth provided in the stator in facing relation to a rotor;
wherein a plurality of coil portions constituting a same phase are formed by winding the winding around each of the plurality of slots; and
an arrangement order of the plurality of unit windings in the radial direction is reversed between the coil portions that are mutually adjacent to each other in the same phase.

8. The winding structure for the rotating electric machine according to claim 7, wherein:
a number of the plurality of unit windings is n;
the plurality of unit windings are arranged in order from a first unit winding, which is a first one of the unit windings, to an nth unit winding, which is an nth one of the unit windings in the radial direction;
in one of the mutually adjacent coil portions, the first unit winding from among the plurality of unit windings is positioned on an outermost side in the radial direction; and
in another of the mutually adjacent coil portions, the first unit winding from among the plurality of unit windings is positioned on an innermost side in the radial direction.

9. The winding structure for the rotating electric machine according to claim 8, wherein an orientation with respect to the radial direction of each of the unit windings from the first unit winding to the nth unit winding is inverted 180 degrees between the mutually adjacent coil portions in the same phase.

10. The winding structure for the rotating electric machine according to claim 7, wherein, in each of the plurality of slots, the winding includes a plurality of turns due to being wound a plurality of times.

11. A winding structure for a rotating electric machine in which a unit winding is formed by bundling a plurality of wires, a winding is formed by bundling a plurality of the unit windings in a radial direction of a stator of the rotating electric machine, and the winding is wound in a plurality of slots formed between a plurality of teeth provided in the stator in facing relation to a rotor;
wherein a plurality of coil portions constituting a same phase are formed by winding the winding around each of the plurality of slots; and
a combination concerning relative positions of each of the unit windings from among the plurality of unit windings across the plurality of coil portions in the same phase is same between the plurality of unit windings.

12. The winding structure for the rotating electric machine according to claim 11, wherein:
the winding is divided into n individual unit windings corresponding to a number of the plurality of coil portions in the same phase;
the plurality of unit windings include those from a first unit winding, which is a first one of the unit windings, to an nth unit winding, which is an nth one of the unit windings; and
there are n combinations of the arrangement order of the plurality of unit windings.

13. The winding structure for the rotating electric machine according to claim 12, wherein:
in the plurality of coil portions, when one of mutually adjacent coil portions is a first coil portion, and another of the mutually adjacent coil portions is a second coil portion,
in the first coil portion, the first unit winding is positioned on an outermost side in the radial direction, and the nth unit winding is positioned on an innermost side in the radial direction; and
in the second coil portion, the nth unit winding is positioned on an outermost side in the radial direction, and the other unit windings are shifted in sequence by one with respect to the unit windings corresponding to the first coil portion.

14. The winding structure for the rotating electric machine according to claim 11, wherein, in each of the plurality of slots, the winding includes a plurality of turns due to being wound a plurality of times.
